(19) United States
(12) Patent Application Publication
(10) Pub. No.: US 2024/0083611 A1
(43) Pub. Date: Mar. 14, 2024

(54) BANDED GARLIC AND SYSTEM FOR AND METHOD OF BANDING

(71) Applicant: SW Ingredients Holdings, LLC, Orlando, FL (US)

(72) Inventor: Keith Price, Bakersfield, CA (US)

(21) Appl. No.: 18/367,244

(22) Filed: Sep. 12, 2023

Related U.S. Application Data
(60) Provisional application No. 63/406,287, filed on Sep. 14, 2022.

(51) Int. Cl. B65B 25/04; A23L 19/00; A23L 27/10; B65B 11/00; B65B 35/10; B65B 53/02; B65D 75/00

(52) U.S. Cl. CPC B65B 25/04; A23L 19/03; A23L 27/105; B65B 11/004; B65B 35/10; B65B 53/02; B65D 75/002

(57) ABSTRACT

The present disclosure relates to a banded garlic product. A banding system and a method of banding garlic is also provided.

### CROSS-REFERENCE TO RELATED APPLICATION

This application claims priority to U.S. Provisional Application No. 63/406,287, filed Sep. 14, 2022, which is herein incorporated by reference in its entirety.

### BACKGROUND

Garlic (Allium sativum) is used worldwide for a variety of purposes, including culinary and medicinal purposes. The garlic plant's bulb or head is the most used part of the plant. The bulb is typically made up of numerous fleshy sections called cloves. Garlic cloves are individually covered with a skin, also referred to as an inner skin or peel. Additional fibrous, papery layers or outer skins or peels cover all the cloves and form the bulb.

Garlic is sold in a variety of forms. When garlic is sold as fresh bulbs, the fibrous, papery layers can break off creating undesired debris, referred to as feathers, during transport, storage and at the point of sale. Additionally, it can be desired that the individual bulbs contain a UPC when fresh garlic bulbs are sold to customers as individual units. This facilitates easier checkout at the point of sale.

### SUMMARY

The present disclosure relates to a banded garlic product. A banding system and a method of banding garlic is also provided.

In example 1, a packaging system for garlic bulbs includes a feed control hopper; a pre-singulation feed belt that receives garlic bulbs from the feed control hopper; a singulation belt that receives the garlic bulbs from the pre-singulation feed and singulates the garlic bulbs; a bander that places a sleeve around the garlic bulbs individually; and a heat shrink unit that applies heat to the sleeve on the garlic bulb to shrink the sleeve such that the sleeve covers a portion of the garlic bulb and two portions of the garlic bulb are exposed.

In example 2, the packaging system of example 1 wherein the singulation belt comprises: a moving belt extending along a longitudinal axis; and a roller assembly attached to the moving belt. The roller assembly includes a roller support configured to attach to the moving belt; a roller extending along a lateral axis, the roller having an hourglass shape with a first cross-sectional diameter at a first end and at a second end and a second cross-sectional shape at a center, wherein the first cross-sectional diameter is larger than the second cross-sectional diameter; and a driver wheel for connecting the roller support and the roller.

In example 3, the packaging system of example 2 wherein the moving belt is a roller chain.

In example 4, the packaging system of example 2 wherein the driver wheel has a protrusion that extends through an opening in the roller support and is received by the roller to connect the roller support and the roller.

In example 5, the packaging system of example 2 wherein the roller support includes: prongs configured to attach to the moving belt; a base connected to the prongs, the base having a first end and a second end and extending along the lateral axis; a first support arm extending vertically upwards from the first end of the base and configured to support the first end of the roller; and a second support arm extending vertically upwards from the second end of the base and configured to support the second end of the roller.

In example 6, the packaging system of example 2 wherein the roller has a slope as measured from the first end to the center from about 0.1 inch/inch to about 1 inch/inch.

In example 7, the packaging system of example 2 wherein the roller has a slope as measured from the first end to the center from about 0.1 inch/inch to about 0.5 inch/inch.

In example 8, the packaging system of example 2 wherein the roller has a slope as measured from the first end to the center from about 0.1 inch/inch to about 0.3 inch/inch.

In example 9, the packaging system of example 2 and further including a ramp configured to accept the driver wheel.

In example 10, the packaging system of example 9 wherein the driver wheel rotates as it travels along the ramp.

In example 11, the packaging system of example 10 wherein the roller rotates as the driver wheel travels along the ramp.

In example 12, the packaging system of example 2 wherein the roller is configured to move the garlic bulb to the center of the roller.

In example 13, a roller assembly for the singulation and individual banding of garlic includes a roller support configured to attach to a belt moving along a longitudinal axis; a roller extending along a lateral axis, the roller having an hourglass shape with a first cross-sectional diameter at a first end and at a second end and a second cross-sectional shape at a center, wherein the first cross-sectional diameter is larger than the second cross-sectional diameter; and a drive wheel for connecting the roller support and the roller.

In example 14, the roller assembly of example 13 wherein the driver wheel has a protrusion that extends through an opening in the roller support and is received by the roller to connect the roller support and the roller.

In example 15, the roller assembly of example 14 wherein the roller support includes prongs configured to attach to the moving belt; a base connected to the prongs, the base having a first end and a second end and extending along the lateral axis; a first support arm extending vertically upwards from the first end of the base and configured to support the first end of the roller; and a second support arm extending vertically upwards from the second end of the base and configured to support the second end of the roller.

In example 16, the roller assembly of example 14 wherein the roller has a slope as measured from the first end to the center from about 0.1 inch/inch to about 1 inch/inch.

In example 17, the roller assembly of example 14 wherein the roller has a slope as measured from the first end to the center from about 0.1 inch/inch to about 0.5 inch/inch.

In example 18, the roller assembly of example 14 wherein the roller has a slope as measured from the first end to the center from about 0.1 inch/inch to about 0.3 inch/inch.

In example 19, an individually packaged garlic bulb comprising a garlic bulb for human consumption; and a heat shrinked sleeve covering a portion of the garlic bulb, wherein two portions of the garlic bulb are exposed to an external environment.

In example 20, the individually packaged garlic bulb of example 19 wherein the heat shrinked sleeve covers about 50% to about 93% of the surface area of the garlic bulb.

In example 21, the individually packaged garlic bulb of example 19 wherein the heat shrinked sleeve covers about 55% to about 93% of the surface area of the garlic bulb.

In example 22, the individually packaged garlic bulb of claim 19 wherein the heat shrinked sleeve covers about 60% to about 93% of the surface area of the garlic bulb.

In example 23, the individual packaged garlic bulb of claim 19 wherein the heat shrinked sleeve includes a UPC.

In example 24, a method of packaging a garlic bulb includes singulating garlic bulbs on a singulation belt; feeding individual garlic bulbs from the singulation belt to a bander; applying a sleeve around the garlic bulb with the bander; and applying heat to the sleeve on the garlic bulb so that the sleeve shrinks to cover a portion of the garlic bulb and two portions of the garlic bulb are exposed.

While multiple embodiments are disclosed, still other embodiments of the present invention will become apparent to those skilled in the art from the following detailed description, which shows and describes illustrative embodiments of the invention. Accordingly, the drawings and detailed description are to be regarded as illustrative in nature and not restrictive.

### BRIEF DESCRIPTION OF THE DRAWINGS

FIG. 1 is a schematic illustration of a banded garlic bulb.

FIG. 2 is a schematic top view of a packaging system.

FIG. 3 is a schematic side view of the packaging system of FIG. 2.

FIG. 4 is a cross-sectional side view of one embodiment of a singulation belt.

FIG. 5 is a cross-sectional side view of the singulation belt of FIG. 4 with a ramp.

FIGS. 6a and 6b are perspective views of embodiments of roller assemblies.

FIG. 7 is an exploded view of a roller assembly.

FIG. 8 is a schematic illustration of a roller.

### DETAILED DESCRIPTION

Garlic is used worldwide as a spice or seasoning for human consumption. Increasing, consumers in the United States and other countries, prefer to buy fresh garlic as compared to dried or powdered forms. Fresh garlic bulbs are covered with papery outer layers that tend to flake or break off creating feathers. Feathers are a particular problem when garlic bulbs are sold individually, for example in bulk bins from which consumers select the bulbs. A new packaging for individual sale of fresh garlic bulbs is disclosed herein. A system and process of using the same are also disclosed.

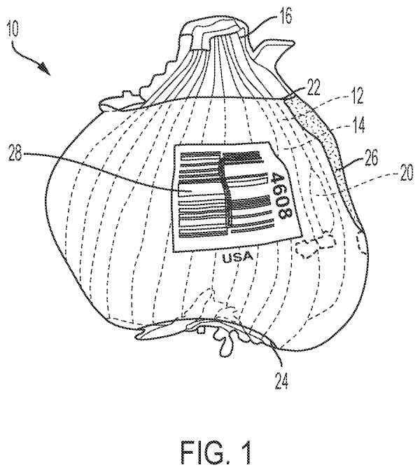

FIG. 1 is a schematic illustration of banded garlic bulb 10 which includes garlic bulb 12 and packaging band 14. Garlic bulb 12 has bulb neck 16 that extends from the top. When garlic bulb 12 is growing in the ground, a stalk would extend from bulb neck 16. The stalk is typically removed from garlic bulb 12 when sold to consumers. Roots (not shown) extend from the bottom of garlic bulb 12 and opposite bulb neck 16. The outside of garlic bulb 12 is covered with outer peel 20 which can comprise several layers of fibrous, papery skin. Outer peel 20 covers a number individual cloves which are arranged in a circle around a central stem.

Packaging band 14 covers a portion of the outer surface of garlic bulb 12. Packaging band 14 has opening at top 22 and bottom 24 (not shown). In some embodiments, packaging band 14 can be a transparent or semi-transparent material. In some embodiments, packaging band 14 is a transparent shrink wrap material which contains one or more images, such as printed branding logo 26 and universal product code (UPC) 28.

Packaging band 14 is a shrink wrap material and can be conformed to the irregular outer shape of garlic bulbs 12. Packaging band 14 does not fully cover garlic bulb 12. In some embodiments, garlic bulb 12 is not covered by packaging band 14 at two separate portions, such as at the top and bottom of garlic bulb 12. For example, bulb neck 16 and roots may be exposed to the external environment and not covered by packaging band 14. In other embodiments, portions of the sides of garlic bulbs 12 may be exposed. In some embodiments, packaging band 14 covers greater than about 50%, 55% or 60% and less than about 90%, 93% or 95% of the surface area of garlic bulb 12.

Garlic bulb 12 can breathe when packaging band 14 does not fully cover the bulb. The openings 22 and 24 in packaging band 14 allow respiration to occur without trapping moisture. In a completely enclosed environment (i.e., if packaging band 14 would cover 100% of the surface of garlic bulb 12), moisture is trapped within the environment. Garlic bulbs 12 may be shipped across large distances and/or stored at various locations as the product is transferred from the packaging facility to point of sale for consumers. Temperatures vary during these activities and the varying temperatures cause the trapped moisture form condensation inside completely enclosed environments, which is detrimental to the quality and shelf life of the garlic and can result in mold growth.

Covering a portion of garlic bulb 12 with packaging band 14 protects outer peel 20 from breaking or flaking and reduces feathers. It also protects outer peel 20 from contaminates, such as dirt and/or germs, that may be spread by customers handling garlic bulbs 12. Packaging band 14 also provides UPC 28 which assists in customer purchasing of banded garlic bulb 10. By only covering a portion of garlic bulb 12, packaging band 14 provides one or more of these benefits while reducing or preventing condensation from forming within the packaging.

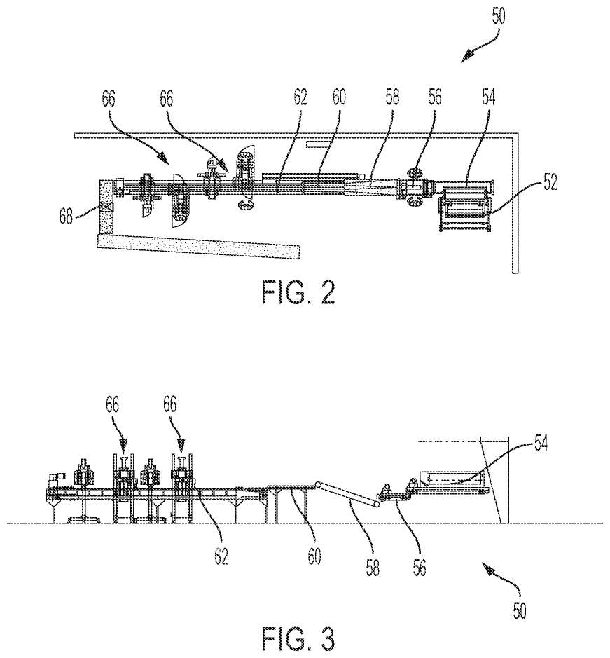

Packaging garlic bulbs 12 with packaging bands 14 using machinery can be challenging because garlic bulbs vary in size and shape. Garlic bulbs can vary from round to oval in shape in three-dimensions. In addition, orienting the garlic in a specific orientation (for example with the neck up and the roots down), to allow banding can further complicate packaging. FIG. 2 is a schematic top view of packaging system 50 and FIG. 3 is a schematic side view of packaging system 50 which bands or packages the garlic bulbs to produce banded garlic bulb 10. Packaging system 50 includes dumper 52, feed control hopper 54, grade or grading belt 56, pre-singulation feed 58, lane alignment belt 60, singulation belt 62, which may include singulation cups, bander 66 and box fill 68.

In operation, dumper 52 provides garlic bulbs to feed control hopper 54. Feed control hopper 54 releases garlic bulbs onto grading belt 56. Feed control hopper 54 controls the results of the garlic bulbs to prevent or reduce backups in the system. In some embodiments, the number of garlic bulbs per time period is approximately equivalent to the number of garlic bulbs the system can package in the same time period.

The garlic bulbs may be optionally graded or inspected on grading belt 56. For example, the garlic bulbs may be inspected and garlic bulbs not meeting size, quality or other qualifications may be removed from the system. Grading belt 56 can be a conveyor belt which moves the garlic bulbs from feed control hopper 54 to pre-singulation feed 58.

Pre-singulation feed 58 can be arranged or oriented as an alignment and singulation belt to singulation belt 62. In some embodiments, pre-singulation feed 58 can be a roller incline conveyer. As shown in FIG. 3, pre-singulation feed 58 can be oriented so that the end adjacent to grading belt 56 is lower than the end adjacent to lane alignment belt 60.

In some embodiments, after pre-singulation feed 58, the garlic bulbs are transported on lane alignment belt 60 and then to singulation belt 62. In other embodiments, lane alignment belt 60 is not present and the garlic bulbs travel from pre-singulation feed 58 directly to singulation belt 62.

Singulation belt 62 separates the individual garlic bulbs. This enables one garlic bulb to be fed to a bander 66 at a time. In one embodiment, singulation belt 62 is a cup conveyer having a plurality of singulation cups. Singulation cups are sized so that a single garlic bulb fits in to a cup. In another embodiment, singulation belt 62 is a dimpled belt in which a single garlic bulb fits into a dimple.

Singulation belt 62 transports the garlic bulbs to bander 66. Singulation belt 62 feeds a single garlic bulb at a time to bander 66. As shown in FIG. 2 and FIG. 3, a plurality of banders 66 may be used with a single singulation belt 62.

At the bander 66, a packaging band or sleeve having an opening at the top and the bottom is placed around the garlic bulb. In one embodiment, bander 66 is an AXON EZ-150 SL bander. The packaging band or sleeve can be a transparent or semi-transparent material as described herein. In one embodiment, the band or sleeve is a heat shrink material.

After the packaging band or sleeve is placed around the garlic bulb, the garlic bulb is exposed to heat for shrink wrap. For example, a heat tunnel or a heat gun can be used to shrink the packaging band or sleeve so that it conforms to the shape of the garlic bulb. In one embodiment, a Quad Pre-shrink System is used for the heat shrink. Preferable, the packaging band or sleeve is shrunk so that the sleeve is not easily removed from the garlic bulb. Thus, the sleeve will remain on the garlic bulb during transportation and at the point of sale.

Once the banded garlic is complete, the product is directed to boxes at box fill 68. The boxes are filled, weighed and palletized.

One key in banding the garlic is to align the bulb to the center of singulation belt 62. Another key to banding the garlic is property spacing the garlic from one another. The singulation belt 62 is designed to align the garlic bulbs to the centerline of singulation belt 62. Spacing is achieved by the timing or speed of singulation belt 62.

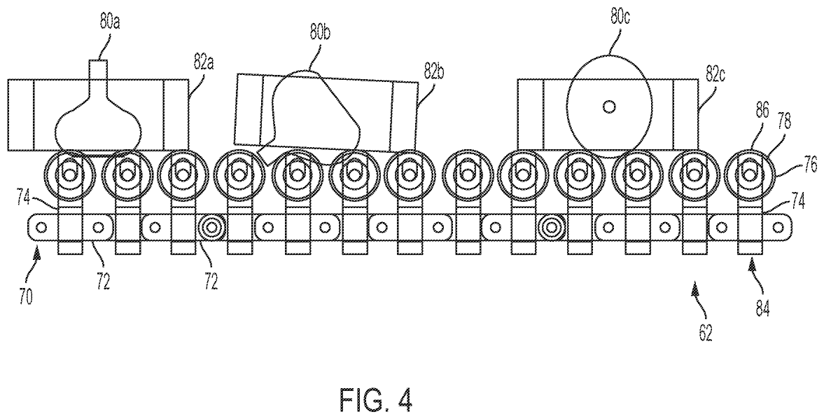

FIG. 4 is a cross-sectional, side-view of one embodiment of singulation belt 62, which orients garlic bulbs 80a, 80b, and 80c (collectively garlic bulbs 80) for the bander(s) to place band 82a, 82b and 82c (collectively band 82) on the respective garlic bulbs 80. Singulation belt 62 includes roller chain 70 (which is formed from a plurality of chain link members 72), roller supports 74, driver wheels 76 and rollers 78. Roller chain 70 is a moving belt which is formed by connecting multiple chain link members 72 to one another. Roller chain 70 extends in the longitudinal direction. In use, roller chain 70 moves in the longitudinal direction (right to left in FIG. 4).

First ends 84 of roller supports 74 connect to chain link members 72. In this way, chain link members 72 carry roller supports 74. Second ends 86 of roller support 74 extend away from roller chain 70. Roller support 74 extends perpendicular to roller chain 70 along a lateral axis and supports the ends of roller 78. Roller support 74 also extends vertically from roller chain 70 such that roller 78 is above roller chain 70. Driver wheel 76 connects to roller 78 and roller support 74.

Various garlic bulbs 80 are shown in FIG. 4. In singulation belt 62, the “singulation cups” take the form of rollers 78. For example, a “cup” is formed between two adjacent rollers 78. A single garlic bulb 80 fits between a pair of adjacent rollers 78. In use, pre-singulation feed 58 feeds or deposits garlic bulbs 80 onto singulation belt 62 such that garlic bulbs 80 are properly spaced apart from one another on singulation belt 62 for banders 66 to band garlic bulbs 80. If garlic bulbs 80 are too close together, banders 66 may not be able to place bands 82 on garlic bulbs 80 and/or heat treat bands 82.

Singulation belt 62 aligns the garlic bulbs 80 along the lateral central axis of singulation belt 62 in order for bands 82 to be properly applied to garlic bulbs 80. In some embodiments, bands 82 must fit over a corner or shoulder of garlic bulbs 80 for a proper fit. If garlic bulb 80 is not centered on singulation belt 62, band 82 will not fit over garlic bulb 80 (for example it will “bounce” off garlic bulb 80) and band 82 will not shrink on garlic bulb 80. As illustrated in FIG. 4, singulation belt 62 can centerline the garlic bulbs 80 regardless of the direction of the stem of garlic bulb 80. In FIG. 4, garlic bulb 80a is sitting upright with the bottom of garlic bulb 80 resting on adjacent rollers 78. Garlic bulb 80b is tipped forward such that bulb neck and bottom of garlic bulb 80b are resting on adjacent rollers 78. Garlic bulb 80c is on its side such that the sides of garlic bulb 80c rest on adjacent rollers 78. Singulation belt 62 allows each bulb to be banded properly despite the different orientations.

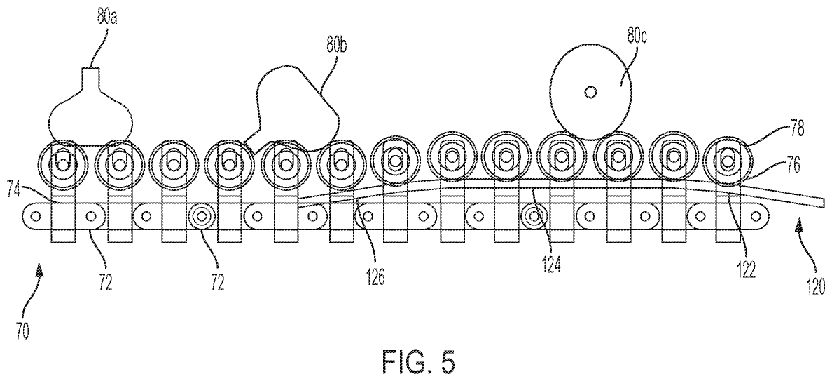

FIG. 5 is a cross-sectional, side-view of singulation belt 64 having ramp 120, which includes upslope portion 122, flat portion 124 and downslope portion 126. In FIG. 5, garlic bulbs 80 move from right to left. In some embodiments, ramp 120 is form by two portions, one on either side of chain 70, with an opening between the two portions for chain 70. In some embodiments, ramp 120 can be from about 1 foot in length to about 10 feet in length.

In use, garlic bulb 80 is transferred from pre-singulation feed 58 or lane alignment belt 60 onto singulation belt 62. Garlic bulb 80 is positioned between two adjacent rollers 78. Ramp 120 engages driver wheels 76 attached to rollers 78. For example, ramp 120 may be formed of a board or slat on either side of chain 70 such that chain 70 moves down the center of ramp 120. Ramp 120 is sized and positioned to engage or lift up driver wheels 76. In some embodiments, ramp 120 is at least as wide as driver wheels 76.

In some embodiments, driver wheels 76 first engage with upslope portion 122. As driver wheels 76 move up upslope portion 122, driver wheels 76 are slowly lifted off the bottom of opening 100 of roller support 74. Driver wheels 76 turn as they pass over or ride along ramp 120. This in turn turns roller 78. The rotation of roller 78 causes garlic bulbs 80 to move on rollers 78 and helps to align garlic bulbs 80 to the center of singulation belt 64. Driver wheels 76 continue across flat portion 124 and then down downslope portion 126. Garlic bulbs 80 are then transported to the bander and heating station as shown in FIGS. 2 and 3.

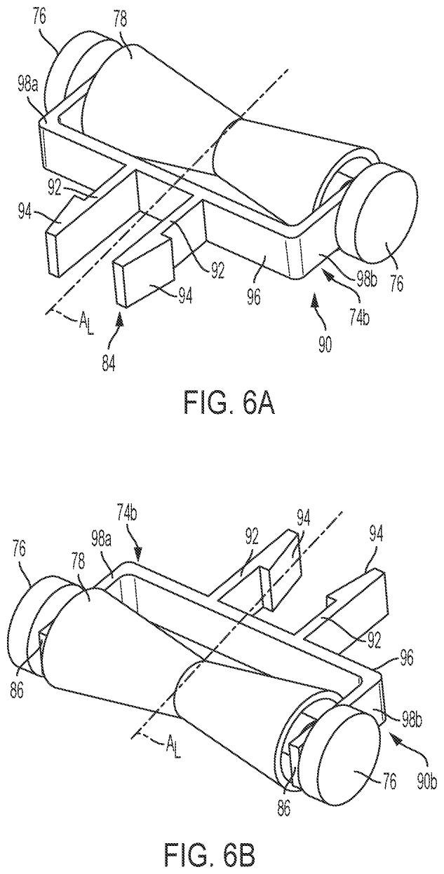

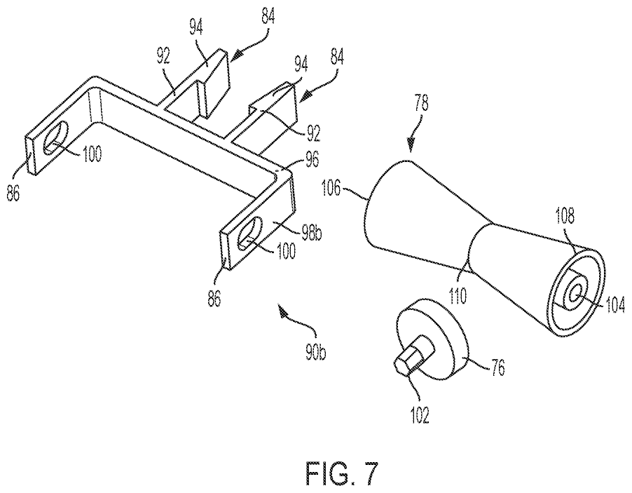

FIG. 6a is a perspective view of roller assemblies 90a (which comprises male roller support 74a, driver wheels 76 and roller 78) and FIG. 6b is a perspective view of roller assembly 90b (which comprises female roller support 74b, driver wheels 76 and roller 78). FIG. 7 is an exploded perspective view of roller assembly 90b. Roller assemblies 90a and 90b (generically roller assembly 90) attach to roller chain 70 by prongs 92 at first end 84. For example, prongs 92 are accepted by and/or connect to roller chain 70. Male roller support 74a has notch 94 on the outside surfaces of each of prongs 92. Female roller support 74b has notch 94 on the inside surface of each of prongs 92. In use, male roller support 74a and female roller support 74b are arranged in an alternating pattern along the length of roller chain 70.

Prongs 92 are attached to base 96 of roller support 74. In use, base 96 extends perpendicular to the length of roller chain 70 and along the lateral axis. Support arms 98 extend vertically upwards from the ends of base 96. A first support arm 98a extends from one end of base 96 and a second support arm 98b extends from the opposite end of base 96. In this way, roller support 74 extends perpendicular to roller chain 70. Support openings 100 are formed in support arms 98. In some embodiments, support openings 100 have a circular or oval shape. Support openings 100 are sized to receive a portion of driver wheel 76 and are configured to allow driver wheel 76 to rotate on ramp 120.

Roller 78 extends between first support arm 98a and second support arm 98b. Driver wheel 76 connects to roller 78 and holds roller 78 in place on first support arm 98a and second support arm 98b. Driver wheel 76 will spin roller 78 during the alignment phase on ramp 120 which helps move garlic bulbs 80 to the best centerline of singulation belt 62.

In some embodiments, driver wheel 76 has a protrusion 102 which fits through opening 104 in first end 106 and second end 108 of roller 78, and driver wheel 76 rotates roller 78 as driver wheel 76 rotates. For example, protrusion 102 may extend through support opening 100 of support arm 98 and be received by opening 104 of roller 78 such that support arm 98 is sandwiched between roller 78 and driver wheel 76. Roller 78 and driver wheel 76 rotate relative to support arm 98 as driver wheel 76 rolls along ramp 120.

Opening 104 extends along the lateral axis through the center of roller 78. In some embodiments, opening 104 can extend the entire length of roller 78. In other embodiments, opening 104 can extend from ends 106 and 108 into a portion of roller 78 to sufficiently receive protrusion 102. Roller 78 can be hollow inside between the outer surface and an outer wall of opening 104 as shown in FIG. 6. Alternatively, roller 78 can be solid between the outer surface and an outer wall of opening 104 at the center of roller 78.

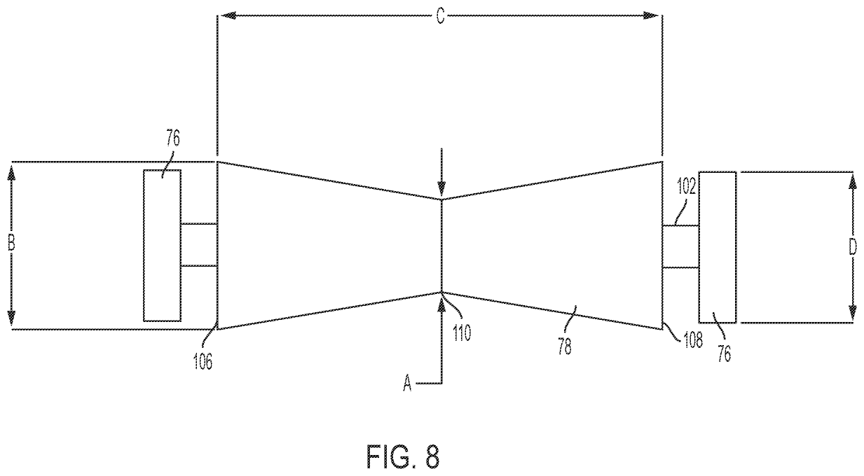

FIG. 8 is a schematic illustration of roller 78. In some embodiments, roller 78 is symmetrical in shape about the lateral axis which extends through first and second ends 106 and 108. Roller 78 can have an hourglass shape with ends 106 and 108 having larger diameters than center 110. For example, roller 78 can have a first cross-sectional diameter at end 106 and at end 108 and a second cross-sectional diameter at center 110, and the first cross-sectional diameter is larger than the second cross-sectional diameter. In this way, roller 78 tapers from end 106 to center 110 and from end 108 to center 110. Center 110 has the smallest diameter on roller 78 and it can be said that a waist is created at center 110. During use, this shape of roller 78 rotates garlic bulbs 80 to the lateral center of roller 78 and singulation belt 62.

The shape of roller 78 also allows bands 82 to settle low enough on garlic bulbs 80 to ensure that the bands 82 sit around the shoulder of garlic bulbs 80 so that when the band 82 shrinks to form the shrink-wrapped wrapper, it shrinks around garlic bulb 80.

Roller 78 is sized to properly space garlic bulbs 80. In FIG. 8, Width A is the width of the narrowest part, or waist, of roller 78, Diameter B is the diameter of first end 106 and second end 108, Length C is the length or roller 78 as measured from first end 106 to second end 108 and Diameter D is the diameter of driver wheel 76. In one embodiment, the slope of roller 78 as measured from the first end 106 to center 110 (or from second end 108 to center 110) is calculated by the equation: (B-A)/(C/2). In some embodiments, because roller 78 is symmetrical, the slope as measured from first end 106 is the same as that measured from second end 108. The slope of roller 78 moves garlic bulbs 80 to the center 110 of the roller. If the slope of roller 78 is too large, garlic bulbs 80 will bounce off roller 78. If the slope of roller 78 is not large enough, garlic bulbs 80 will not move to center 110. In some embodiments, the slope of roller 78 of from 0.1 inch/inch to about 1 inch/inch, from about 0.1 inch/inch to about 0.6 inch/inch, from about 0.1 inch/inch to about 0.4 inch/inch, or from about 0.1 inch/inch to about 0.3 inch/inch.

Width A, Diameter B and Length C can be chosen to provide the appropriate slope on roller 78 and to control and change the spacing of garlic bulbs 80 on singulation belt 62 and/or capacity of singulation belt 62.

The rotational speed of roller 78 and the length of time of the rotational area also affect the system. If roller 78 rotates too slowly, garlic bulbs 80 may not move to center 110. If roller 78 rotates too quickly, garlic bulbs 80 may not move because there is slippage between roller 78 and garlic bulb 80. In some cases, roller 78 moving too quickly can strip the skin from the outside of garlic bulb 80, which is not desirable. The rotational speed of roller 78, which can be adjusted by changing Diameter D and the speed of chain 70, can be from about 1 ft/min to about 300 ft/min.

While garlic is used in the above examples, other produce, such as onions may also be used.

Various modifications and additions can be made to the exemplary embodiments discussed without departing from the scope of the present invention. For example, while the embodiments described above refer to particular features, the scope of this invention also includes embodiments having different combinations of features and embodiments that do not include all of the above described features.

The following is claimed:

1. A packaging system for garlic bulbs, the system comprising:
a feed control hopper;
a pre-singulation feed belt that receives garlic bulbs from the feed control hopper;
a singulation belt that receives the garlic bulbs from the pre-singulation feed and singulates the garlic bulbs;
a bander that places a sleeve around the garlic bulbs individually; and
a heat shrink unit that applies heat to the sleeve on the garlic bulb to shrink the sleeve such that the sleeve covers a portion of the garlic bulb and two portions of the garlic bulb are exposed.

2. The packaging system of claim 1 wherein the singulation belt comprises:
a moving belt extending along a longitudinal axis; and
a roller assembly attached to the moving belt, the roller assembly including:
a roller support configured to attach to the moving belt;
a roller extending along a lateral axis, the roller having an hourglass shape with a first cross-sectional diameter at a first end and at a second end and a second cross-sectional shape at a center, wherein the first cross-sectional diameter is larger than the second cross-sectional diameter; and
a driver wheel for connecting the roller support and the roller.

3. The packaging system of claim 2 wherein the moving belt is a roller chain.

4. The packaging system of claim 2 wherein the driver wheel has a protrusion that extends through an opening in the roller support and is received by the roller to connect the roller support and the roller.

5. The packaging system of claim 2 wherein the roller support includes:
prongs configured to attach to the moving belt;
a base connected to the prongs, the base having a first end and a second end and extending along the lateral axis;
a first support arm extending vertically upwards from the first end of the base and configured to support the first end of the roller; and
a second support arm extending vertically upwards from the second end of the base and configured to support the second end of the roller.

6. The packaging system of claim 2 wherein the roller has a slope as measured from the first end to the center from about 0.1 inch/inch to about 1 inch/inch.

7. The packaging system of claim 2 wherein the roller has a slope as measured from the first end to the center from about 0.1 inch/inch to about 0.5 inch/inch.

8. The packaging system of claim 2 wherein the roller has a slope as measured from the first end to the center from about 0.1 inch/inch to about 0.3 inch/inch.

9. The packaging system of claim 2 and further including a ramp configured to accept the driver wheel.

10. The packaging system of claim 9 wherein the driver wheel rotates as it travels along the ramp.

11. The packaging system of claim 10 wherein the roller rotates as the driver wheel travels along the ramp.

12. The packaging system of claim 2 wherein the roller is configured to move the garlic bulb to the center of the roller.

13. A roller assembly for the singulation and individual banding of garlic, the roller assembly comprising:
a roller support configured to attach to a belt moving along a longitudinal axis;
a roller extending along a lateral axis, the roller having an hourglass shape with a first cross-sectional diameter at a first end and at a second end and a second cross-sectional shape at a center, wherein the first cross-sectional diameter is larger than the second cross-sectional diameter; and
a drive wheel for connecting the roller support and the roller.

14. The roller assembly of claim 13 wherein the driver wheel has a protrusion that extends through an opening in the roller support and is received by the roller to connect the roller support and the roller.

15. The roller assembly of claim 14 wherein the roller support includes:
prongs configured to attach to the moving belt;
a base connected to the prongs, the base having a first end and a second end and extending along the lateral axis;
a first support arm extending vertically upwards from the first end of the base and configured to support the first end of the roller; and
a second support arm extending vertically upwards from the second end of the base and configured to support the second end of the roller.

16. The roller assembly of claim 14 wherein the roller has a slope as measured from the first end to the center from about 0.1 inch/inch to about 1 inch/inch.

17. The roller assembly of claim 14 wherein the roller has a slope as measured from the first end to the center from about 0.1 inch/inch to about 0.5 inch/inch.

18. The roller assembly of claim 14 wherein the roller has a slope as measured from the first end to the center from about 0.1 inch/inch to about 0.3 inch/inch.

19. An individually packaged garlic bulb comprising:
a garlic bulb for human consumption; and
a heat shrinked sleeve covering a portion of the garlic bulb, wherein two portions of the garlic bulb are exposed to an external environment.

20. The individually packaged garlic bulb of claim 19 wherein the heat shrinked sleeve covers about 50% to about 93% of the surface area of the garlic bulb.
